(19) United States
(12) Patent Application Publication
(10) Pub. No.: US 2026/0264117 A1
(43) Pub. Date: Sep. 10, 2026

(54) APPARATUS FOR REMOVING A COATING FROM AN EXTERNAL SURFACE OF PENSTOCK, SYSTEM AND METHOD

(71) Applicant: K. A. Cooper Pty Ltd, Mowbray, Tasmania (AU)

(72) Inventor: Kerry Andrew COOPER, Mowbray, Tasmania (AU)

(73) Assignee: K. A. Cooper Pty Ltd, Mowbray, Tasmania (AU)

(21) Appl. No.: 19/167,854

(22) PCT Filed: Mar. 21, 2024
(86) PCT No.: PCT/AU2024/050255

§ 371 Date: Sep. 23, 2025

(30) Foreign Application Priority Data
Mar. 23, 2023 (AU) 2023900809

(51) Int. Cl. B08B 9/023; B62D 21/02; B62D 21/18

(52) U.S. Cl. CPC B08B 9/023; B62D 21/02; B62D 21/18; B08B 2209/02

(57) ABSTRACT

An apparatus for removing a coating from an external surface of penstock, comprising: a vehicle frame having means for supporting the apparatus on and facilitating travelling along the external surface of the penstock; a cleaning head; and a ring which substantially encircles the penstock and forms a track along which the cleaning head can travel, wherein the ring is hinged to allow it to be opened and expanded so as to pass over flanges joining adjacent sections of the penstock.

### FIELD OF THE INVENTION

The present invention relates to an apparatus for removing a coating from an external surface of penstock, a system and a related method.

### BACKGROUND

The size, construction and location of penstock makes external maintenance difficult, particularly when an external coating of the penstock is required to be removed. External maintenance is required as the life span of penstock is typically many decades and although the surface deteriorates slowly, it still requires periodic maintenance to ensure operation of the hydroelectric system. This maintenance typically requires removing the external coating or paint from the penstock and then preparing the surface for re-coating.

Adding to these difficulties is that for penstock installed a long time ago, lead paint may have been used, resulting in strict occupational health and safety measures needing to be adopted for operators working in such environments and causing an environmental hazard if it is not contained during the removal process.

Presently, removing a coating from an external surface of penstock is done manually with high pressure water jets. Abrasives are then applied under pressure to the surface to prepare the surface for re-coating, again manually. These operations are both slow and difficult to perform due to the size of the penstock and operator safety requirements, and also unpleasant as safety standards require that such operations be performed by users wearing onerous personal protection equipment to protect them from hazardous materials.

Furthermore, penstock are often differently configured from one site to the next. In particular, some have a smooth outer surface whereas others are provided with external strengthening ribs which make cleaning difficult, particularly between or around the external ribs.

There is a need to address the above, and/or at least provide a useful alternative.

### SUMMARY

According to a first aspect of the invention there is provide an apparatus for removing a coating from an external surface of penstock, comprising:
a vehicle frame having means for supporting the apparatus on and facilitating travelling along the external surface of the penstock;
a cleaning head; and
a ring which substantially encircles the penstock and forms a track along which the cleaning head can travel,
wherein the ring is hinged to allow it to be opened and expanded so as to pass over flanges joining adjacent sections of the penstock.

In a preferred embodiment, the means for supporting the apparatus includes a plurality of wheels that travel along the external surface of the penstock.

Preferably, a plurality of wheels pairs are provided, the wheel pairs being individually liftable to allow the apparatus to walk over flanges which join adjacent sections of penstock.

Preferably, the cleaning head forms a space in which at least one nozzle is supported, the space acting to contain overspray from the at least one cleaning nozzle. The cleaning head can include a mechanism to oscillate the nozzle. The cleaning head can be provided with a nozzle for supplying a jet of water. The cleaning head can also be provided with a nozzle for applying a stream of compressed air and an abrasive medium.

Preferably, the cleaning head further comprises rollers, the rollers supporting at least one magnet from the surface of the penstock to draw the cleaning head to the surface during cleaning. The cleaning head can have the shape of a dome.

Preferably, the cleaning head is fluidly connected to a suction line to create a suction within the cleaning head to capture debris.

The apparatus can further comprise lateral stabilisers extending from each side of the vehicle frame and being movable between engaged and disengaged positions, the stabilisers including magnets for locking the apparatus to the external surface when in the engaged position to facilitate cleaning.

According to another aspect of the invention there is provided a system for removing a coating from an external surface of penstock, comprising:
an apparatus of the above described type;
a winch for drawing the apparatus along the penstock;
a supply of pressurised water for cleaning the external surface,
a supply of compressed air and abrasive material for removing paint from the external surface; and
a vacuum supply to collect debris from the cleaning head.

In a preferred embodiment, the system further comprises a water filtration system for filtering water captured after cleaning the external surface

The system can further include a support vehicle configured to travel beside the penstock, the support vehicle having a tank and a pump to supply the pressurised water, a compressor to supply the compressed air, a vacuum pump to form the vacuum supply. The system can further comprise a storage tank for storing captured water and/or abrasive material and debris.

According to another aspect of the invention, there is provided a method of removing a coating from an external surface of penstock, comprising the steps of:
a) providing an apparatus of the above described type;
b) positioning the apparatus on the penstock at a first position;
c) moving the cleaning head along the ring and providing pressurised water to the cleaning head to remove paint from the external surface along a circumferential band; and
d) advancing the apparatus along the penstock to a second location; and
e) repeating steps (c) and (d) to remove the surface coating from a length of penstock.

The method can further include the step of providing abrasive media and compressed air to the cleaning head to prepare the external surface for re-coating.

Preferably, the step of advancing the apparatus along the penstock is performed by winching the apparatus. Preferably, the means for supporting the apparatus on and facilitating travelling along the external surface of the penstock is a series of wheels and in advancing the apparatus along the penstock, the wheels are individually liftable to allow the apparatus to travel over flanges joining adjacent sections of penstock.

### BRIEF DESCRIPTION OF THE DRAWINGS

In order that the invention may be more easily understood, an embodiment will now be described, by way of example only, with reference to the accompanying drawings, in which:

FIG. 1 is a perspective view of series of penstock installed at a hydroelectric site.

FIG. 2 is a perspective view of a section of penstock.

FIG. 3 is a perspective view of an apparatus for removing a coating from an external surface of penstock according to a preferred embodiment of the invention.

FIG. 4 is a rear end view of the apparatus.

FIG. 5 is a side view of the apparatus.

FIG. 6 is a plan view of the apparatus.

FIG. 7 is an end view of the apparatus, with ring 16 in an open state.

FIG. 8 is a lower perspective view of a cleaning head of the apparatus.

FIG. 9 is a plan view of the cleaning head.

FIG. 10 is an underneath close view of the cleaning head.

FIG. 11 is a close view of wheels provided at each corner of the apparatus.

FIG. 12 is a plan view of central wheels of the apparatus.

FIGS. 13 and 14 are plan and perspective views of stabilisers of the apparatus.

FIGS. 15a to 15c are side views of wheels at the front of the apparatus, and

FIG. 16 is a close view of a magnetic stabiliser of the apparatus.

### DETAILED DESCRIPTION

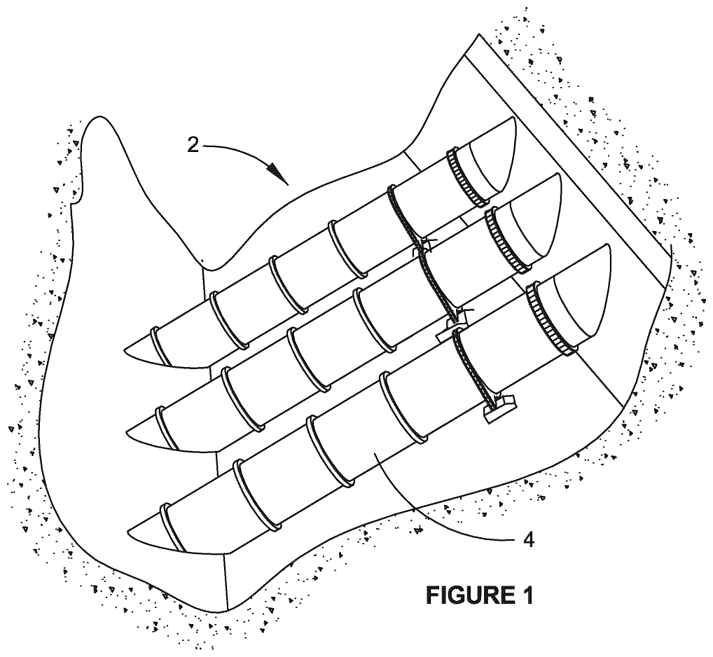

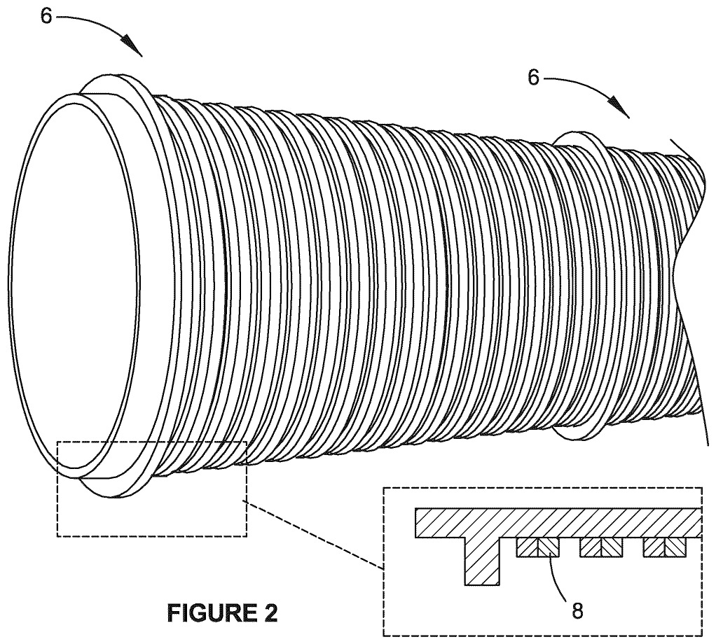

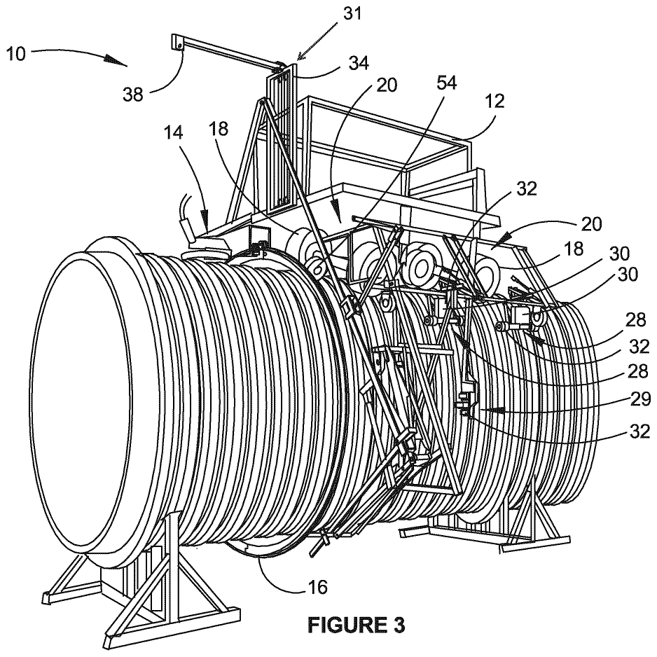

FIG. 3 illustrates an apparatus 10 according to a preferred embodiment of the invention. The apparatus 10 is configured for removing a coating from an external surface of penstock. The apparatus is also be configured for preparing a surface of the penstock for re-coating, this preparation step including applying an abrasive material to the external surface.
FIG. 1 illustrates a typical hydroelectric installation 2 including a series of three lines of penstock 4 mounted end to end. The penstock 4 of FIG. 1 have a smooth external surface. In contrast, the penstock 6 of FIG. 2 have external strengthening ribs 8 welded to an external surface.

Apparatus 10 generally comprises a vehicle frame 12, a cleaning head 14 and a ring 16. It is illustrated in a simplified form with certain detail omitted for clarity purposes, such as pneumatic hoses, electrical cables or control systems.

### Vehicle Frame

The vehicle frame 12 is a space frame structure that supports the different components of the apparatus 10. The vehicle frame has means for supporting the apparatus 10 on the penstock and for facilitating the apparatus to travel along the external surface of the penstock, which in the illustrated embodiments are a plurality of wheels 18.

At each corner of the vehicle frame 12 are pairs 20 of wheels 18, each pair 20 having a common axle 22 that is on an angle of approximately 25 degrees to accommodate a 3.0 m diameter pipe. Internal axles are angled at approximately 18 degrees. Each wheel pair 20 is independently liftable via a pneumatic actuator to allow the apparatus 10 to pass over flanges securing adjacent sections of penstock together.

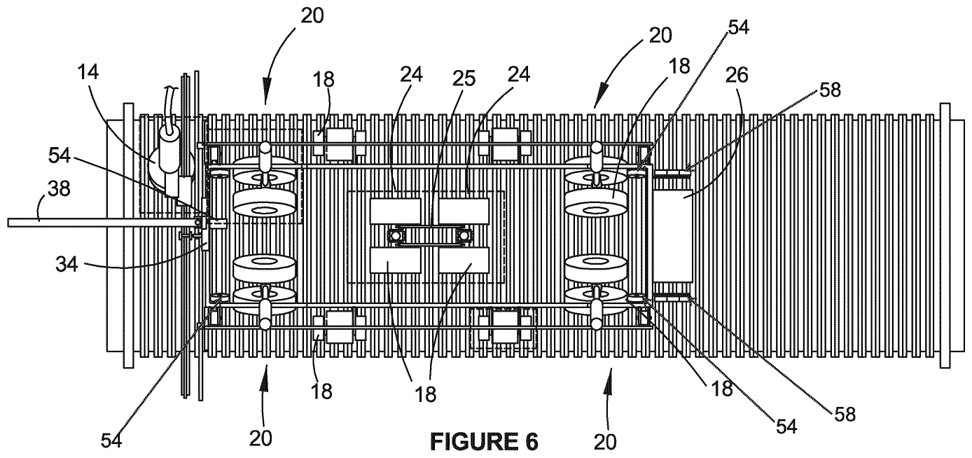

As can be seen in FIG. 6, generally rigid support rollers 54 are also provided at the aft or downhill end of the vehicle at corners of the vehicle frame 12 to support the weight of the apparatus 10 and accommodate deflation of pneumatic wheels under heavy loads, such as when an abrasive blast head is used. These wheels are 10″ diameter wheels and also act to steer apparatus 10. In use, apparatus 10 is facing down the penstock, which could be inclined from 17 to 38 degrees, over a length of 2 to 5 kms. The axles of rollers 54 are installed immediately adjacent to the arms of ring 16.

At the front or uphill end of the apparatus 10, on either side thereof, are guide wheel assemblies 58. Each guide wheel assembly 58 includes three wheels mounted on a support 60, with the support 60 rotating to allow the assembly 58 to move over a flange on the penstock. Wheel assemblies 58 can be adjusted to suit the penstock flanges, ensuring the primary interaction with the pipe flange is aligned. In addition, the assemblies 58 can alert the operator of in appropriate tyre deflation of the pneumatic wheels 18.

With reference to FIG. 6, in the illustrated embodiment, a further two pairs 24 of wheels 18 are centrally mounted on the vehicle frame 12 and offset longitudinally. Pairs 24 are also independently liftable via pneumatic actuators mounted on each axle. Secondary actuators 25 between each axle may be provided to control movement of the wheel pairs 24, particularly to adjust toe-in and toe-out. Secondary actuators 25 also allow for steering of the apparatus 10 to ensure that it maintains a straight course along the penstock and avoids falling from either side.

Those skilled in the art will appreciate that the number, size and type of wheels used will be dictated by the final weight of the apparatus 10, and that less or additional support wheels may be used in alternative embodiments of the invention. Those skilled in the art will also appreciate that a certain weight is required to counter a reaction force from the cleaning head and keep the apparatus 10 in position while cleaning. To this end it can be helpful to increase the weight of the machine over what is needed. To this end, apparatus 10 includes ballast tank 26 secured at a forward end (i.e. in the direction of travel) of the vehicle frame 12. Ballast tank 26 is configured to hold 120 l of water, though they may be of larger or smaller capacity and more than one tank may be provided.

The wheel pairs 20, 24 are configured so that as the apparatus 10 is moved along the penstock, they are automatically lifted by proximity switches actuating electric over pneumatic valves which hold out a relay until the proximity switch no longer reads the flange and the wheels return to the crown of the pipe as required to allow the apparatus 10 to effectively ‘walk’ over flanges which join adjacent sections of penstock. To facilitate walking, three pairs of wheels, spaced longitudinally on the apparatus 10, may be required, so that at least two pairs are in contact with the penstock at any one time if one pair is travelling over the flange.

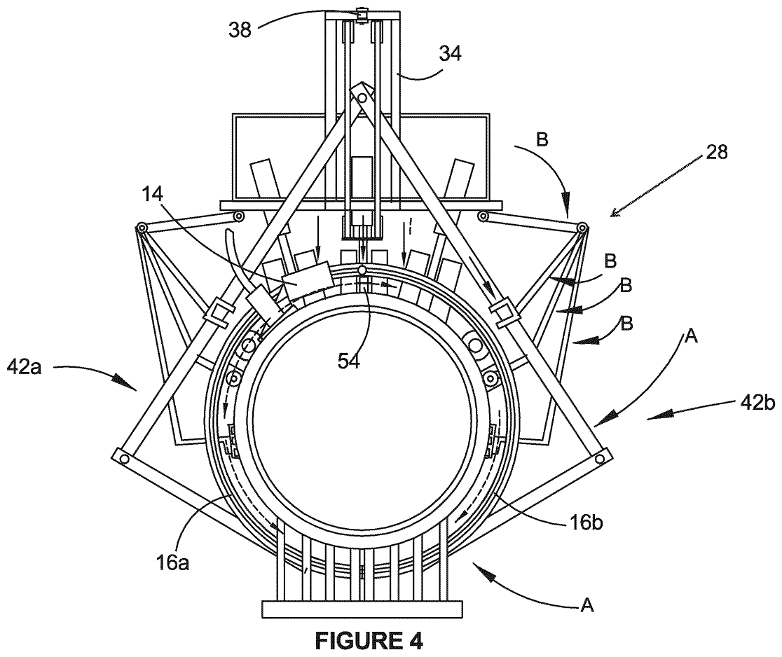

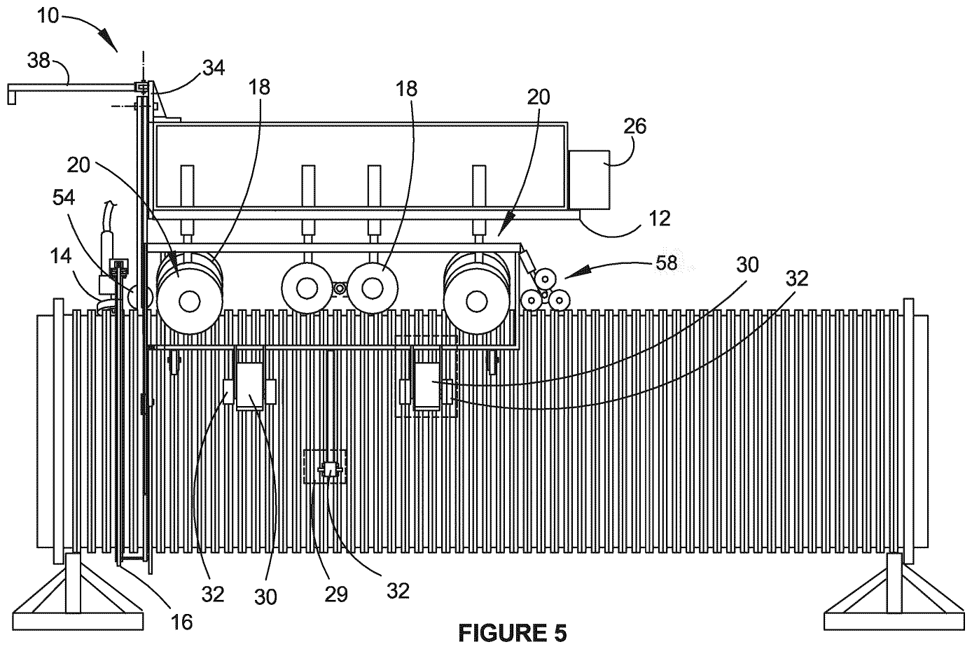

As can be seen in FIG. 3, the vehicle frame 12 also includes lateral stabilisers 28 extending from each side thereof via a pipe spring line. Stabilisers 28 act to stabilise the apparatus 10 of the penstock and hold it in position during operation of the cleaning head 14. In the illustrated embodiment, the stabilisers 28 are mounted to the vehicle frame 12 and movable between an engaged position in which they contact the penstock and a disengaged position where they are spaced from the penstock to allow movement of the apparatus. Movement between the engaged position and disengaged position is achieved by using mechanical mechanisms and pneumatic actuators to lift each stabiliser 28 from the penstock. During movement, arms of the stabilisers move along path B shown in FIG. 4.

The stabilisers 28 include magnets 30 for locking the apparatus to the external surface when in the engaged position to facilitate cleaning. The magnets may be permanent magnets made of commonly available materials such as neodymium, though other types of magnets such as electromagnets may also be used.

The stabilisers 28 also include rollers 32 to engage the external surface of the penstock. The stabilisers 28 are configured so that when the rollers 32 are in contact with the surface of the penstock, the magnets 30 are spaced from the surface a small amount, such as 3-5 mm.

In the illustrated embodiment, apparatus 10 has two stabilisers 28 mounted close to the vehicle frame 12 on each side thereof, plus a further stabiliser 29 also mounted to the vehicle frame 12, though extending further from the vehicle frame 12 to provide additional support. Stabiliser 29 is provided with a series of rollers 32 but no magnets and activated with proximity switches to automatically clear the penstock flange during movement of the apparatus 10.

At a rearward end of the vehicle frame 12 is a support structure 34 that works with cables 36 to lift the ring 16, as will be further described below. Attached to the support structure 34 is a boom 38 that is configured to swing from side to side and from which cables and hoses are mounted.

### Ring

Secured to a rearward end of vehicle frame 12 is a ring 16 which substantially encircles the penstock. Ring 16 provides a track for cleaning head 14 (described further below) to travel around.

In the illustrated embodiments, ring 16 completely encircles the penstock. Such a ring provides good structural strength so as to support the cleaning head 14, though it will be appreciated that the ring may also be incomplete and not completely encircle the penstock, though such a ring may require additional reinforcement to carry and support the cleaning head 14.

In use, the cleaning head 14 completes a full 360 degree pass over the penstock, cleaning/preparing a band around the penstock, by travelling around the ring 16 approximately 180 degrees on one side, then approximately 180 degrees on the other side. It will be appreciated that the hoses will stop the cleaning head moving a full 360 degrees around the penstock. When cleaning the surface and removing paint with high pressure water, the width of the band is in the range of 120 mm×35 mm and band spacing is 70 mm. When applying abrasive media, the width of the band is in the range of 120×35 mm with a 75 mm spacing. Band size variation is of no consequence as the oscillating water jet and or abrasive blast nozzles capture the face of the band, edge and recess void of a vortex created by propulsion. The AS/NZ standard for Ultra high pressure water is 4233, parts 1 and 2.

After the cleaning head 14 completes a pass the apparatus 10 is moved along the penstock so that an adjacent band is cleaned, preferably ensuring that no part of the surface of the penstock has been missed. To facilitate moving of the apparatus 10, cleaning head 14 is lifted from the surface of the penstock, stabilisers 28 disengaged and the apparatus 10 moved. It may be possible to retain the ring 16 in the closed position while moving the apparatus, though it may also be preferred to fully open it during movement to surpass or clear Penstock support saddles. Full opening of the ring 16 will be required when passing over flanges that join adjacent sections of the penstock together.

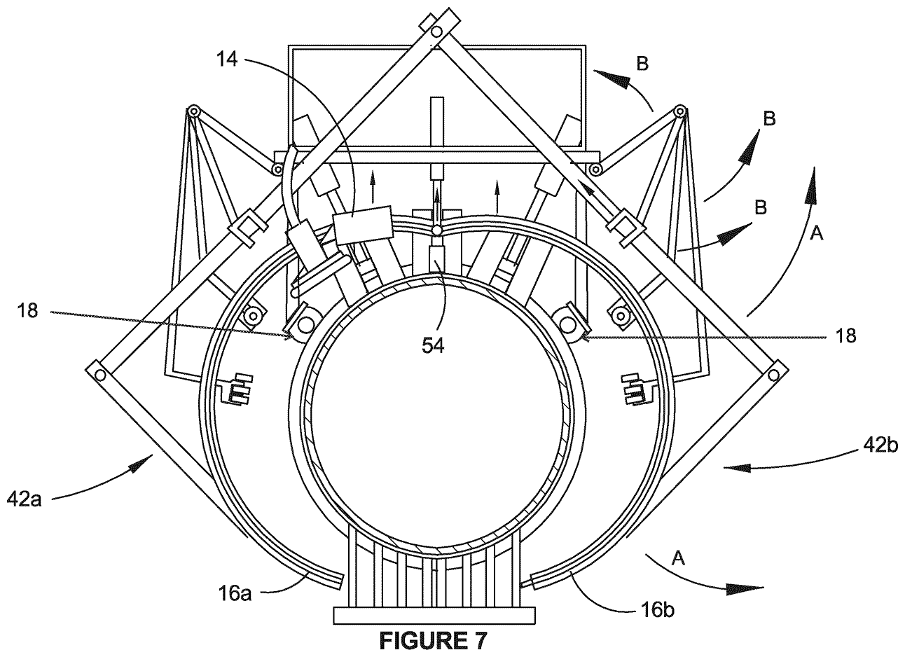

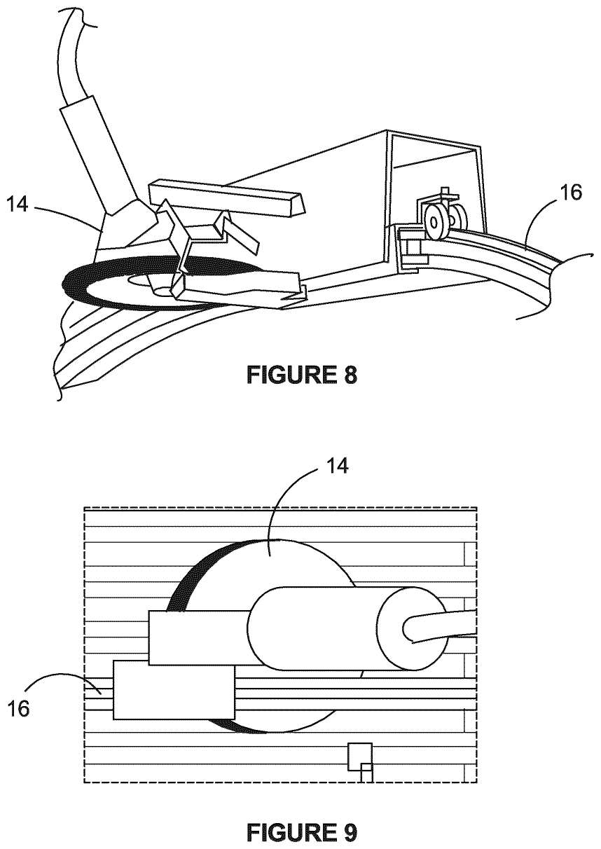

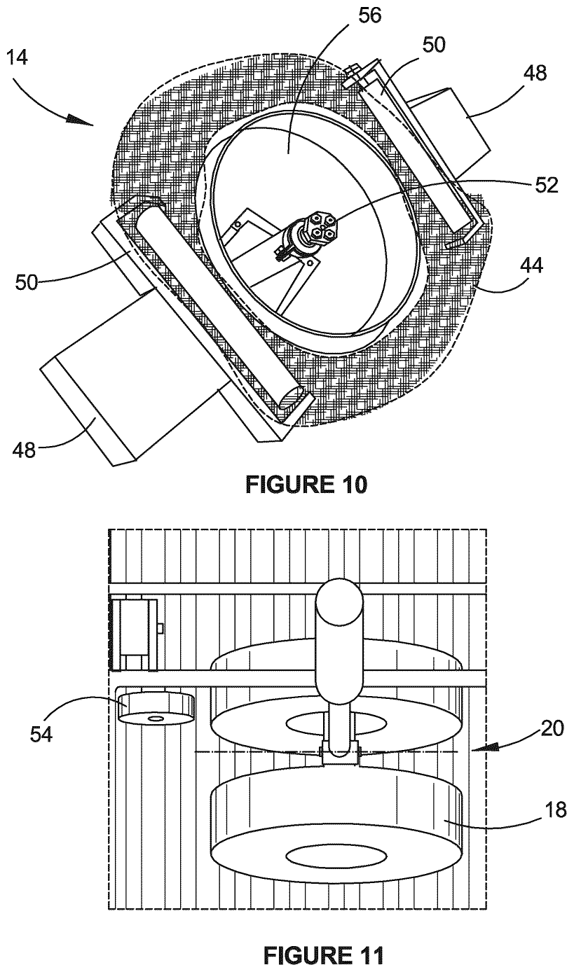

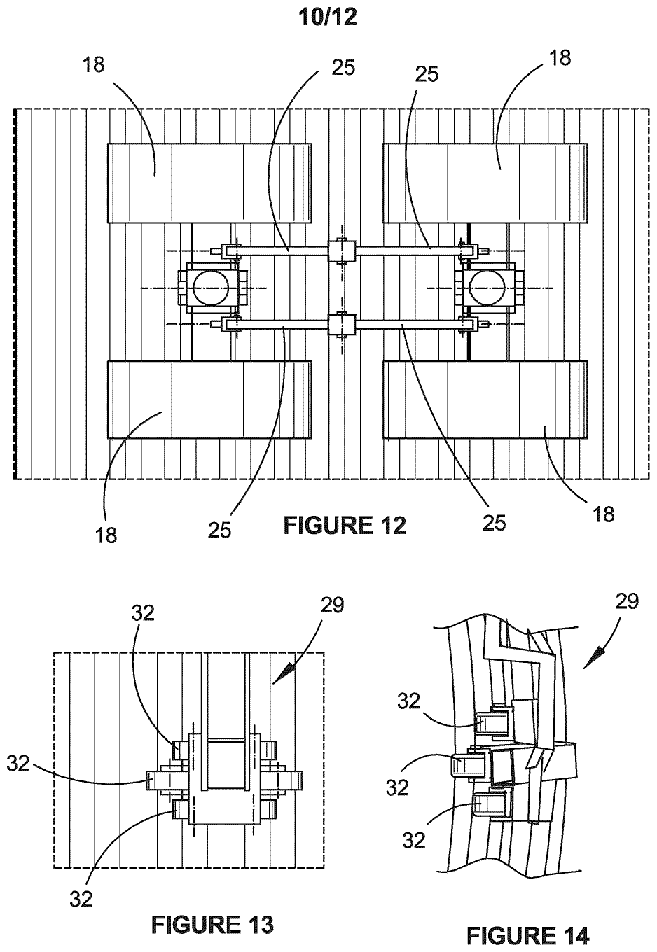

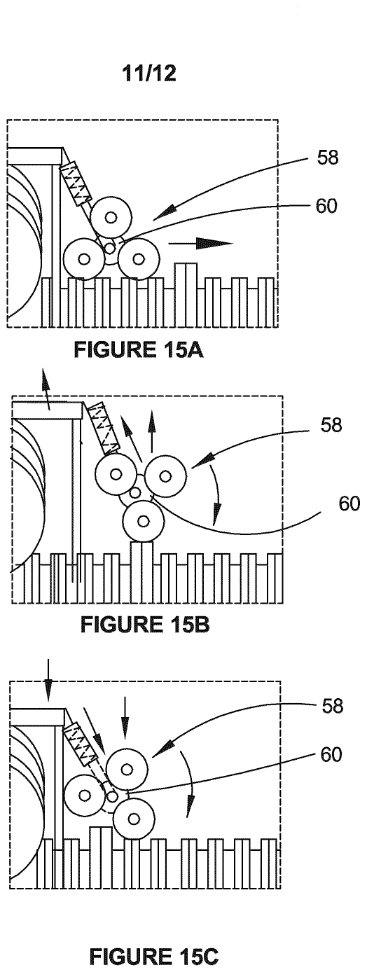

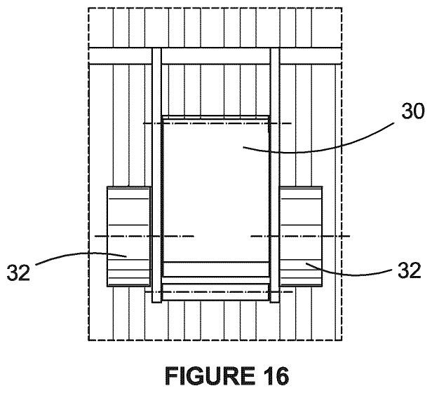

As can be seen in FIG. 7, ring 16 is formed from two main parts 16a, 16b that engage each other at a lowermost point, the join coming apart during opening. At an uppermost section of the ring 16, there may be an intermediate section (not shown) that forms part of the track and has a curvature to match the rest of the ring. If provided, at ends of the intermediate section there are pin joints that allow connection of the parts of the ring 16a, 16b. This essentially forms a double hinge, as distinct from the single hinged joint shown. It will be appreciated that a guide may be required to allow ends of the ring to come back together after opening to ensure successful recoupling. End of ring 16 are also configured for engagement with each other without creating an obstacle to the cleaning head 14 as it passes over the join.

With reference to FIG. 7, mechanisms 42a, 24b are provided on sides of the apparatus 10, extending from the vehicle frame 12. The mechanisms 42a, 42b are secured in position pneumatically. Mechanisms 42a & 42B lift via a fulcrum mechanism activated by a 20:1 sheaves on the mast 31 winch lifting mechanism and act to draw apart the sides of the ring 16a, 16b and lift the ring 16 when ring 16 is required to be opened and expanded. As part of the process of opening the ring 16, it may be lifted via the cables 36 and support structure 34. Operation of ring 16 is shown in FIG. 4, with the apparatus 10 configured so that as mast 31 lifts the ring, mechanisms 42a and 42b draw the sides outwardly along path A-A.

### Cleaning Head

As mentioned above, cleaning head 14 passes around penstock on a track formed on ring 12 to clean or provide surface preparation to an annular band around a circumference of the penstock. To facilitate movement, cleaning head 14 is provided with wheels that travel along a corresponding track formed on the ring. A drive motor is provided and which may be a commercially available 240 v 0.37 kw A/C motor. The drive is facilitated by a 10:1 gearbox coupled to the 0.37 kw motor. A 14 tooth sprocket locates the 32b chain to drive the motor circumferentially around the ring 16.

Proximity sensors are provided in the cleaning head to control movement of the head around the 16.

In one operation, the cleaning head 14 provides a high-pressure water jet to clean and remove paint from an external surface of the penstock. In another operation, the cleaning head 14 applies an abrasive media under high pressure to remove and remaining paint and prepare the surface of the penstock for further painting operations. Although both functions may be performed by a single head, preferably interchangeable heads are used.

Those skilled in the art will appreciate that a single cleaning head may be configured to perform both operations, though in alternative embodiments there may be two separate cleaning heads that are interchangeable and selectively used as required, indicative to the surface preparation required IE UHP water Jet or Abrasive Blast.

Preferably, the apparatus 10 will perform the first operation with a first cleaning head 14a having water jet nozzles 52 fitted therein, along a length of the penstock before returning to complete the second operation with a second cleaning head 14b having blast nozzles for applying abrasive media.

Both cleaning heads 14a, 14b are generally dome shaped and form a space 56 in which at least one nozzle is supported, the space acting to contain overspray from the or each nozzle. A brush 44 may be provided around a periphery of an opening of the cleaning head 14 to capture debris.

The first cleaning head 14a is fitted with four #18 nozzles that provide a water jet at 40,000 PSI. Using these four nozzles results in an overall flow rate of 21 litres per minute.

To contain the spray within the cleaning head 14a and capture debris, it is necessary to mount the nozzles close to a surface of the penstock however, this could reduce the width of application down to around 60 mm and increases the time taken for the cleaning process. To increase the width of application and reduce the time taken for the cleaning process, the nozzles are configured to oscillate from side to side within the cleaning head 14a, thereby increasing the width of application to around 200 mm, in conjunction with, 2000 cfm vacuum system utilising 3″ vacuum hose roots blower (28 inches of mercury), which captures the debris produced.

To provide oscillating movement to the nozzles, the cleaning head 14a includes a mechanism that extends from within the dome to external thereof, where it can be driven by a reciprocating pneumatic cylinder. Those skilled in the art will appreciate that the speed of oscillation will vary according to the speed of travel of the cleaning head 14a, the type of surface coating being removed, the water jet pressure, and flow rate. Preferably, the speed of oscillation will be variable and controllable. The cleaning head 14 is configured with oscillating nozzles that work with both the water jets or abrasive blasters.

Cleaning head 14b operates to prepare the surface of the penstock for a subsequent surface coating, which is typically paint, though other surface coatings may also be used following the preparation step. Cleaning head 14b is provided with a blast nozzle for applying a stream of compressed air and an abrasive medium. The blast nozzle is preferably a #7 or #8 nozzle, though it will be appreciated that the type and number of nozzles used may vary according to the pressure of compressed air available, the type of abrasive media used and the condition of the penstock after the first cleaning operation. The abrasive media may be any commercially available media, though it is preferably Australian Garnet GMA #30/60 mesh with a Measurement of Hardness MOH of 6 to 8. The stream of compressed air supplying the abrasive media is preferably air at a pressure of 120-130 psi. The AS/NZ standard for Ultra high-pressure water is 4233, Parts 1 and 2.

This implementation of oscillating variable nozzle (@ 40K psi) adjustment avails WJ 1 to WJ4 (Nace cleaning identification) 1 being corrosion and coating removed, 4 being cleaned of all contaminates. Abrasive Blasting AS/NZ 1627.4 achieves the following variables with the oscillating blast nozzles x 2. NO.8 Nozzles (1/2″ orifice @ 400 CFM each) Class 1 to class 3, where Class 3 is white steel with no shading.

The cleaning head 14b is fluidly connected to a suction line to create a suction within the cleaning head to capture debris and remove the used abrasive media. In a preferred embodiment, the suction line draws 2000 cfm in a vacuum system utilising 3″ vacuum hose roots blower (28 inches of mercury), which captures the debris produced at a rate of 80 % on banded pipe (20% remaining does not contain contaminates as the toxic dust is lighter and is a primary capture. 100% vacuum can be achieved on a non-banded pipe.

Those skilled in the art will appreciate that cleaning heads 14a, 14b will potentially be heavy and due to the high pressures involved, large reaction forces may be encountered. To reduce the forces applied to the ring, both cleaning heads 14a, 14b further comprises means to draw them to the surface of the penstock. In this regard, at least one magnet is provided, the or each magnet being mounted on rollers 50 that support the magnets 3 to 5 mm from the surface of the penstock, to allow the cleaning head to be moved. It will be appreciated that a single magnet may be used, or multiple magnets. In the illustrated embodiment, two magnets 48 are used. The magnet is preferably a permanent rare earth magnet formed of neodymium, though other materials or types of magnets such as electromagnets may also be used. Preferably, a mass of 250 kg of magnetic material is used.

### Painting Mechanism

Apparatus 10 may also be configured to paint the penstock after surface preparation with the cleaning heads 14a or 14b being demountable and replaced with a spray painting attachment (not shown).

As some Penstocks are banded pipe it is paramount the spray application is arranged to capture the top, sides and recess of the band. To facilitate uniform protective coating, spraying is at specified coating film thickness i.e. 125 microns, using the following process.

Airless application to the Penstock is performed via 2 automatic spray guns, pneumatically controlled at the operators consol.

A plural component pump is provided which pressurises and doses material at the required ratio e. g 4:1 to dosing valves and creates an exothermic airless spray line to the automatic guns.

Spray tip selection preferably enables high solids paint be applied to the surface with the variables being in tip orifice selection 415 airless tip=0.0015 thou orifice 4=8″ fan.

Primer is applied to the penstock completely encapsulating bands and pipe void of excessive overspray. Once the two-component primer is dry the unit is retracted and two component top coat is applied.

Spray application speed is governed by the 0.37 kw drive motor facilitating the required film thickness, at the operators consol.

### Laser Surface Preparation

The apparatus 10 may also be provided with a laser (not shown) to facilitate laser surface preparation for difficult to reach parts of the penstock, such as around the flanges. Preferably, the laser is a 2kw dual axis laser which is on an extended arm that goes between the penstock mounting saddles.

The laser may also be configured to oscillate so that a wider band of the penstock can be reached.

### System

Apparatus 10 is configured for full remote operation via a PLC controller and a handheld control unit. Each of the mechanisms/actuators used may be pneumatic or otherwise electrically controlled. Advantageously, operators are no longer required to climb onto the penstock or access platforms to perform cleaning operations.

Apparatus 10 is not provided with a drive system for driving its wheels, though such a system may be provided in other embodiments. One difficulty with providing a drive system to the apparatus 10 is that penstock are often angled and as the angle increases, traction between the drive system and the penstock is difficult, particularly as the apparatus 10 traverses flanges joining together adjacent sections of penstock.

To move the apparatus 10 along the penstock it is winched upwards or lowered downwards on the penstock via an external winch (not shown) secured on the penstock. The winch (not shown) may be mounted to the penstock via a strap encircling the penstock.

At a forward end of the apparatus 10 are two cables 46, each being secured to a side of the vehicle frame 12 and coming together to meet a single winch cable that extends to the winch. Such an arrangement provides that the apparatus 10 can be pulled up or lowered down the penstock generally evenly or straight.

Steering the apparatus 10 is predominately performed via wheels 54 and whilst winching or free spooling down the incline of the penstock. The steer is by means of PLC interaction with longitude and latitude readers. If variation occurs left or right, the variation is audited by the longitude and latitude readers which continually adjust the steering automatically and adjust it with Linear actuators controlling the wheels 54.

In addition to the winch, a support vehicle travelling along the ground beside the penstock may be provided to follow the apparatus 10. The support vehicle may include a supply of pressurised water for cleaning the external surface, a supply of compressed air and abrasive material for removing paint from the external surface; and a vacuum supply to collect debris from the cleaning head.

In addition, the support vehicle may have a generator to supply electrical power to the apparatus 10. This may include 240 v power for the drive motor of the cleaning head 14, as well as a 12 v power for controlling the pneumatic actuators.

A water filtration system may be provided for filtering water captured after cleaning the external surface. Advantageously, wastewater is not required to be disposed of and can be reused by the apparatus 10. A water filtration system is particularly useful where the external coating on the penstock included lead-based paint which is toxic/hazardous and requires treatment prior to either releasing to the environment or reuse.

The support vehicle may include a tank and a pump to supply the pressurised water, a compressor to supply the compressed air, and a vacuum pump to form the vacuum supply. The support vehicle may further include a storage tank for storing captured water and/or abrasive material and debris.

Many modifications of the above embodiments will be apparent to those skilled in the art without departing from the scope of the present invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An apparatus for removing a coating from an external surface of penstock, comprising:
a vehicle frame having means for supporting the apparatus on and facilitating travelling along the external surface of the penstock;
a cleaning head; and
a ring which substantially encircles the penstock and forms a track along which the cleaning head can travel,
wherein the ring is hinged to allow it to be opened and expanded so as to pass over flanges joining adjacent sections of the penstock.

2. An apparatus according to claim 1, wherein the means for supporting the apparatus includes a plurality of wheels that travel along the external surface of the penstock.

3. An apparatus according to claim 2, wherein a plurality of wheels pairs are provided, the wheel pairs being individually liftable to allow the apparatus to walk over flanges which join adjacent sections of penstock.

4. An apparatus according to claim 1 wherein the cleaning head forms a space in which at least one nozzle is supporters, the space acting to contain overspray from the at least one cleaning nozzle.

5. An apparatus according to claim 4, wherein the cleaning head includes a mechanism to oscillate the nozzle.

6. An apparatus according to claim 1, wherein the cleaning head is provided with a nozzle for supplying a jet of water.

7. An apparatus according to claim 1, wherein the cleaning head is provided with a nozzle for applying a stream of compressed air and an abrasive medium.

8. An apparatus according to claim 1, wherein the cleaning head further comprises rollers, the rollers supporting at least one magnet from the surface of the penstock to draw the cleaning head to the surface during cleaning.

9. An apparatus according to claim 1, wherein the cleaning head has the shape of a dome.

10. An apparatus according to claim 1, wherein the cleaning head is fluidly connected to a suction line to create a suction within the cleaning head to capture debris.

11. An apparatus according to claim 1, further comprising lateral stabilisers extending from each side of the vehicle frame and being movable between engaged and disengaged positions, the stabilisers including magnets for locking the apparatus to the external surface when in the engaged position to facilitate cleaning.

12. A system for removing a coating from an external surface of penstock, comprising:
an apparatus according to claim 1;
a winch for drawing the apparatus along the penstock;
a supply of pressurised water for cleaning the external surface,
a supply of compressed air and abrasive material for removing paint from the external surface; and
a vacuum supply to collect debris from the cleaning head.

13. A system according to claim 12, further comprising a water filtration system for filtering water captured after cleaning the external surface

14. A system according to claim 12, including a support vehicle configured to travel beside the penstock, the support vehicle having a tank and a pump to supply the pressurised water, a compressor to supply the compressed air, a vacuum pump to form the vacuum supply.

15. A system according to claim 14, further comprising a storage tank for storing captured water and/or abrasive material and debris.

16. A method of removing a coating from an external surface of penstock, comprising the steps of:
a) providing an apparatus according to claim 1;
b) positioning the apparatus on the penstock at a first position;
c) moving the cleaning head along the ring and providing pressurised water to the cleaning head to remove paint from the external surface along a circumferential band; and
d) advancing the apparatus along the penstock to a second location; and
e) repeating steps (c) and (d) to remove the surface coating from a length of penstock.

17. A method according to claim 16, further including the step of providing abrasive media and compressed air to the cleaning head to prepare the external surface for re-coating.

18. A method according to claim 16, wherein the advancing the apparatus along the penstock is performed by winching the apparatus.

19. A method according to any one of claims 16, wherein the means for supporting the apparatus on and facilitating travelling along the external surface of the penstock is a series of wheels and in advancing the apparatus along the penstock, the wheels are individually liftable to allow the apparatus to travel over flanges joining adjacent sections of penstock.
